(19) United States
(12) Patent Application Publication
(10) Pub. No.: US 2019/0033632 A1
(43) Pub. Date: Jan. 31, 2019

(54) VIEWING ANGLE SWITCHABLE LIQUID CRYSTAL DISPLAY DEVICE AND VIEWING ANGLE SWITCHING METHOD

(71) Applicant: Infovision Optoelectronics (Kunshan) Co., Ltd., KunShan City, JiangSu Province (CN)

(72) Inventors: HUNG-MING LEE, KunShan City, JiangSu Province (CN); HSI-CHIEN LIN, KunShan City, JiangSu Province (CN); LI WEI KUNG, KunShan City, JiangSu Province (CN); XIAO MENG, KunShan City, JiangSu Province (CN); YUN XU, KunShan City, JiangSu Province (CN)

(73) Assignee: Infovision Optoelectronics (Kunshan) Co., Ltd., KunShan City, JiangSu Province (CN)

(21) Appl. No.: 16/073,792

(22) PCT Filed: Aug. 11, 2016
(86) PCT No.: PCT/CN2016/094645

§ 371 Date: Jul. 29, 2018

(51) Int. Cl. G02F 1/13; G02F 1/1343; G02F 1/1347; G02F 1/1335; G02F 1/133

(52) U.S. Cl. CPC G02F 1/1323; G02F 1/134363; G02F 1/13306; G02F 1/133526; G02F 1/133602; G02F 1/1347

(57) ABSTRACT

A liquid crystal display device and a viewing angle switching method are provided. The liquid crystal display device includes a display panel, a backlight source, and a light adjustment liquid crystal film disposed between the display panel and the backlight source. The light adjustment liquid crystal film includes an upper substrate, a lower substrate disposed opposite to the upper substrate, and a liquid crystal layer located between the upper substrate and the lower substrate. The upper substrate is provided with an upper electrode on a side thereof facing the lower substrate. The lower substrate is provided with a lower electrode on a side thereof facing the upper substrate. The light adjustment liquid crystal film is configured to change a backlight exit angle of the light emitted by the backlight after passing through the display panel by applying a voltage between the upper electrode and the lower electrode.

### TECHNICAL FIELD

The present application relates to the technical field of liquid crystal display, and more particularly to a viewing angle switchable liquid crystal display device and a viewing angle switching method.

### BACKGROUND

Liquid crystal display (LCD) has the advantages of good picture quality, small size, light weight, low driving voltage, low power consumption, no radiation and relatively low manufacturing cost, and is dominant in the field of flat panel display.

With the continuous development of liquid crystal display technology, the viewing angle of a display panel has been broadened from original 120° to more than 160°. While enjoying the visual experience brought by the large viewing angle, people also want to effectively protect commercial secrets and personal privacy to avoid the business losses or embarrassment caused by leakage of screen information.

FIG. 1 is a schematic cross-sectional view of a conventional liquid crystal display device. The crystal display device includes a display panel 100 and a backlight source 140. A light-blocking film 150 is disposed between the display panel 100 and the backlight source 140. Alternatively, the light-blocking film 150 may be attached to an upper surface of the display panel 100. The light-blocking film 150 blocks the large-angle light of the backlight source 140 and allows the small-angle light to pass through, so as to realize a narrow viewing angle mode by reducing the luminance of the backlight source 140. However, one light-blocking film 150 can only provide one viewing angle. Once the light-blocking film 150 is attached, the viewing angle is fixed. Thus, the display panel 100 can only realize a narrow viewing angle, and cannot realize a wide viewing angle.

FIG. 2 and FIG. 3 are schematic cross-sectional views of another conventional liquid crystal display device. The display panel 100 of the liquid crystal display device includes a first substrate 110, a second substrate 120, and a liquid crystal layer 130 located between the first substrate 110 and the second substrate 120. The first substrate 110 is provided with an electrode 111 for controlling viewing angle.

As shown in FIG. 2, the electrode 111 on the first substrate 110 is not supplied with a voltage during a wide viewing angle mode, and the display panel 100 works normally so as to realize the wide viewing angle mode. As shown in FIG. 3, when a narrow viewing angle mode is required, the electrode 111 on the first substrate 110 is supplied with a voltage so that the liquid crystal molecules in the liquid crystal layer 130 are tilted due to a vertical electric field (as indicated by arrows E) while rotating horizontally. The contrast ratio of the display panel 100 decreases due to light leakage, thus achieving a narrow viewing angle mode.

Please also refer to FIG. 4 and FIG. 5, the liquid crystal display device further includes a backlight source 140 located below the display panel 100. The light provided by the backlight source 140 towards the display panel 100 is of a scattering type. Assuming that the backlight exit angle of the backlight source 140 is θ₁, the screen viewing angle of the display panel 100 is θ₂ (generally referring to the viewing angle when the contrast is greater than 10). When the display panel 100 is displayed in a wide viewing angle mode, the screen viewing angle θ₂ of the display panel 100 and the backlight exit angle θ₁ of the backlight source 140 are substantially equal and both are in a wide viewing angle (as shown in FIG. 4). When the display panel 100 is switched to display in a narrow viewing angle mode, the screen viewing angle θ₂ of the display panel 100 is reduced, but the backlight exit angle θ₁ of the backlight source 140 is still in a large angle (as shown in FIG. 5). A white screen phenomenon may occur in a screen area between the two angles θ₁, θ₂ (i.e., in an area corresponding to θ₃), which may cause a white screen problem when viewed from a large viewing angle in the narrow viewing angle mode.

It can be seen from the above, the existing two ways to achieve a narrow viewing angle mode include reducing the luminance of the backlight source and reducing the contrast of the display panel. However, any one of the above two ways has its own disadvantages in use. Therefore, it is necessary to provide a liquid crystal display device capable of switching between a wide viewing angle mode and a narrow viewing angle mode in order to easily realize switching of viewing angle on different occasions.

### SUMMARY

The present application is intended to provide a viewing angle switchable liquid crystal display device and a viewing angle switching method, to solve the shortcomings of the existing ways in switching viewing angle and realize switching between a wide viewing angle mode and a narrow viewing angle mode on different occasions easily.

The present application provides a viewing angle switchable liquid crystal display device in an embodiment. The liquid crystal display device includes a display panel and a backlight source. The liquid crystal display device further includes a light adjustment liquid crystal film disposed between the display panel and the backlight source. The light adjustment liquid crystal film includes an upper substrate, a lower substrate disposed opposite to the upper substrate, and a liquid crystal layer located between the upper substrate and the lower substrate. The upper substrate is provided with an upper electrode on a side thereof facing the lower substrate. The lower substrate is provided with a lower electrode on a side thereof facing the upper substrate. The light adjustment liquid crystal film is configured to change a backlight exit angle of the light emitted by the backlight after passing through the display panel by applying a voltage between the upper electrode and the lower electrode.

Further, when the voltage applied between the upper electrode and the lower electrode continuously changes, the backlight exit angle is continuously variable between a maximum exit angle and a minimum exit angle.

Further, the upper substrate is further provided with a prism layer. The prism layer includes a plurality of prisms. The prisms are arranged side by side along a first direction of the display panel, and each prism extends along a second direction of the display panel.

Further, the light adjustment liquid crystal film has two in quantity. Arrangement directions of the prism layers on the two light adjustment liquid crystal films are perpendicular to each other.

Further, one of the two light adjustment liquid crystal films is disposed between the display panel and the backlight source, and the other light adjustment liquid crystal film is disposed above the display panel.

Further, the liquid crystal display device is provided with a viewing angle adjusting button for sending a viewing angle adjusting request to the liquid crystal display device.

Further, the display panel includes a first substrate, a second substrate disposed opposite to the first substrate, and a liquid crystal layer located between the first substrate and the second substrate. The first substrate is provided with a first electrode on a side thereof facing the second substrate. The second substrate is provided with a second electrode and a third electrode on a side thereof facing the first substrate. The second electrode is a common electrode, the third electrode is a pixel electrode, and a screen viewing angle of the display panel is changed by applying a voltage between the first electrode and the second electrode.

Further, when the voltage applied between the first electrode and the second electrode continuously changes, the screen viewing angle is continuously variable between a maximum viewing angle and a minimum viewing angle.

The present application further provides a viewing angle switching method of a liquid crystal display device in an embodiment. The liquid crystal display device includes a display panel and a backlight source. The liquid crystal display device further includes a light adjustment liquid crystal film disposed between the display panel and the backlight source. The light adjustment liquid crystal film includes an upper substrate, a lower substrate disposed opposite to the upper substrate, and a liquid crystal layer located between the upper substrate and the lower substrate. The upper substrate is provided with an upper electrode on a side thereof facing the lower substrate. The lower substrate is provided with a lower electrode on a side thereof facing the upper substrate. The viewing angle switching method includes:

Applying a voltage between the upper electrode and the lower electrode according to a viewing angle adjusting request, such that a backlight exit angle of the light emitted from the backlight source after passing through the display panel is changed by the light adjustment liquid crystal film.

Further, the display panel includes a first substrate, a second substrate disposed opposite to the first substrate, and a liquid crystal layer located between the first substrate and the second substrate. The first substrate is provided with a first electrode on a side thereof facing the second substrate. The second substrate is provided with a second electrode and a third electrode on a side thereof facing the first substrate. The second electrode is a common electrode. The third electrode is a pixel electrode. The viewing angle switching method further includes:

Applying a voltage between the first electrode and the second electrode according to a viewing angle adjusting request, such that a screen viewing angle of the display panel is changed.

Further, the backlight exit angle is controlled to be equal to or smaller than the screen viewing angle.

Further, the liquid crystal display device is provided with a viewing angle adjusting button, and the viewing angle adjusting request is sent to the liquid crystal display device via the viewing angle adjusting button.

According to the viewing angle switchable liquid crystal display device and the viewing angle switching method provided by the embodiments of the present application, a light adjustment liquid crystal film is disposed between the display panel and the backlight source. When there is a need for privacy protection, a required voltage is applied between the upper electrode and the lower electrode of the light adjustment liquid crystal film, the scattered light generated by the backlight source is converged by the light converging effect of the light adjustment liquid crystal film, the luminance of the backlight source in large viewing angle is reduced to realize a narrow backlight exit angle, so that the display panel is displayed in a narrow viewing angle mode.

Further, when the display panel is the IPS type or the FFS type having wide viewing angle, a voltage is also applied between the first electrode (i.e., the viewing angle control electrode) and the second electrode (i.e., the common electrode) of the display panel, so that the display panel generates a light leakage and reduces the contrast of the screen, to decrease the screen viewing angle of the display panel. Thus, a narrow viewing angle mode can be achieved by simultaneously reducing the contrast of the display panel and reducing the luminance of the backlight source in large viewing angle, thereby solving the white screen problem as viewed from large viewing angle when displayed a narrow viewing angle mode. The viewing angle is narrower and the effect is better.

### BRIEF DESCRIPTION OF THE DRAWINGS

FIG. 1 is a schematic cross-sectional view of a conventional liquid crystal display device.

FIG. 2 is a schematic cross-sectional view of another conventional liquid crystal display device in a wide viewing angle mode.

FIG. 3 is a schematic cross-sectional view of the liquid crystal display device of FIG. 2 in a narrow viewing angle mode.

FIG. 4 is a schematic view of the viewing angle of the liquid crystal display device of FIG. 2 in a wide viewing angle mode.

FIG. 5 is a schematic view of the viewing angle of the liquid crystal display device of FIG. 2 in a narrow viewing angle mode.

FIG. 6 is a schematic cross-sectional view of a liquid crystal display device in a wide viewing angle mode according to a first embodiment of the present application.

FIG. 7 is a schematic cross-sectional view of the liquid crystal display device of FIG. 6 in a narrow viewing angle mode.

FIG. 8 is a cross-sectional view of a liquid crystal display device in a wide viewing angle mode according to a second embodiment of the present application.

FIG. 9 is a schematic cross-sectional view of the liquid crystal display device of FIG. 8 in a narrow viewing angle mode.

FIG. 10 is a schematic cross-sectional view of a liquid crystal display device according to a third embodiment of the present application.

FIG. 11 is a cross-sectional view of a liquid crystal display device in a wide viewing angle mode according to a fourth embodiment of the present application.

FIG. 12 is a cross-sectional view of the liquid crystal display device of FIG. 11 for illustrating the white screen phenomenon.

FIG. 13 is a schematic cross-sectional view of the liquid crystal display device of FIG. 11 in a narrow viewing angle mode.

FIG. 14 is a schematic cross-sectional view of a liquid crystal display device according to a fifth embodiment of the present application.

FIG. 15 is a schematic cross-sectional view of a liquid crystal display device according to a sixth embodiment of the present application.

FIGS. 16a to 16b are schematic plan views of a liquid crystal display device according to a seventh embodiment of the present application.

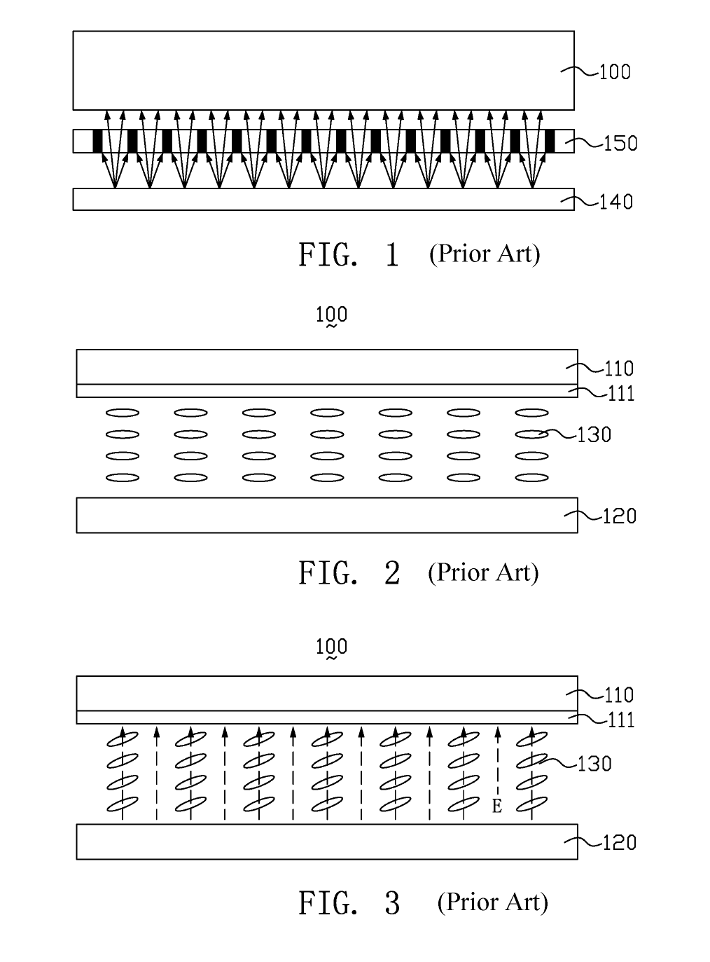

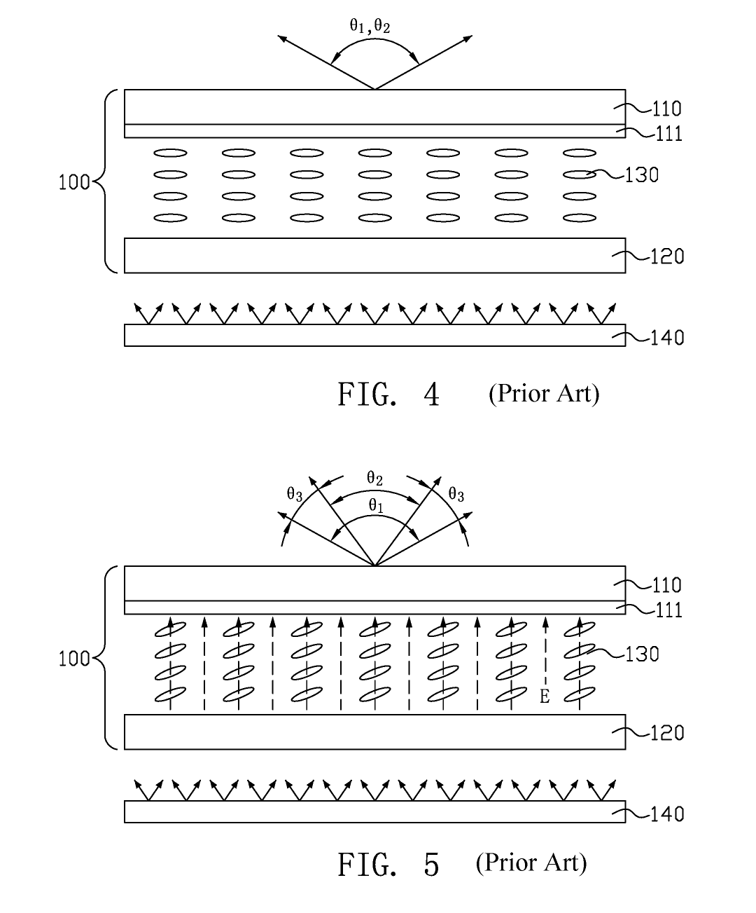

### DETAILED DESCRIPTION OF PREFERRED EMBODIMENTS

In order to make the purposes, characteristics, and advantages of the present application more apparently, embodiments of the present application will now be described in more detail with reference to the drawing figures.

### First Embodiment

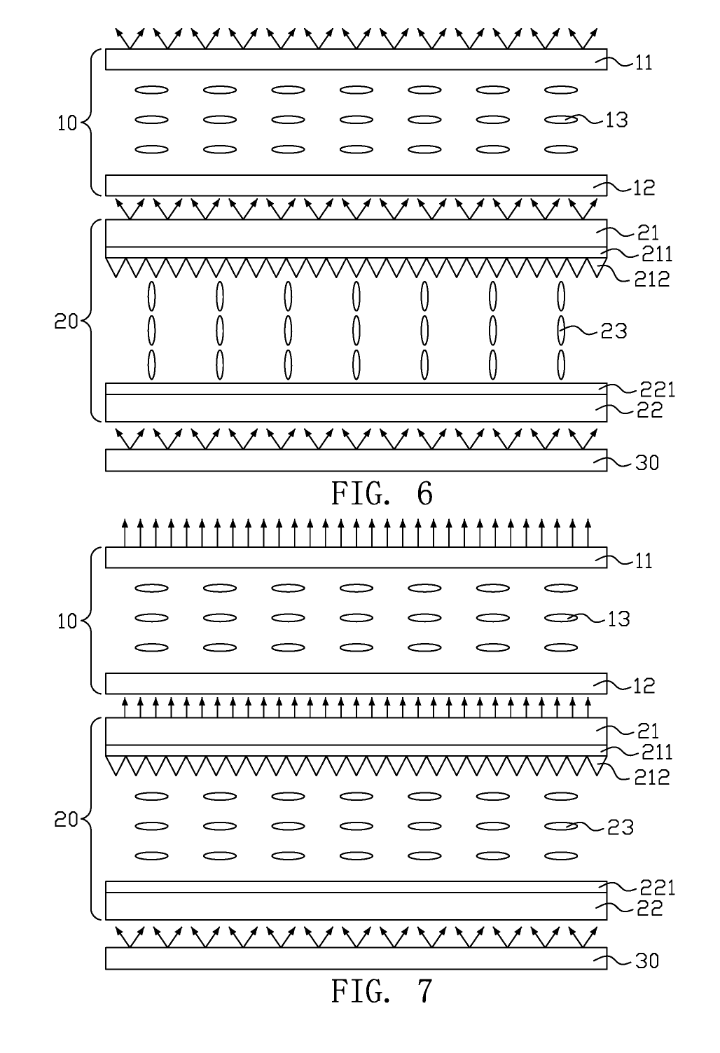

FIG. 6 is a schematic cross-sectional view of a liquid crystal display device in a wide viewing angle mode according to a first embodiment of the present application. FIG. 7 is a schematic cross-sectional view of the liquid crystal display device of FIG. 6 in a narrow viewing angle mode. Referring to FIG. 6 and FIG. 7, the liquid crystal display device includes a display panel 10, a light adjustment liquid crystal film 20 and a backlight source 30. The backlight source 30 is configured to provide the display panel 10 with a light source for display. The light adjustment liquid crystal film 20 is disposed between the display panel 10 and the backlight source 30. The light adjustment liquid crystal film 20 can adjust a backlight exit angle of the light emitted by the backlight source 30 after passing through the display panel 10.

The display panel 10 includes a first substrate 11, a second substrate 12 disposed opposite to the first substrate 11, and a liquid crystal layer 13 disposed between the first substrate 11 and the second substrate 12. The first substrate 11 and the second substrate 12 are, for example, a glass substrate or a plastic substrate. The first substrate 11 is, for example, a color filter substrate, and a filter film (not shown) of three colors of red (R), green (G) and blue (B) is formed on the first substrate 11. The second substrate 12 is, for example, a thin film transistor array substrate, and a thin film transistor array, i.e., a TFT array (not shown), is formed on the second substrate 12.

The backlight source 30 may be a side-type or a direct-type backlight. In this embodiment, the backlight source 30 has a wide divergence angle so that the backlight can obtain a wide divergence angle after passing through the display panel 10. When a narrow divergence angle is needed, the light emitted by the backlight source 30 is converged by the light adjustment liquid crystal film 20, so that the backlight can obtain a narrow divergence angle after passing through the display panel 10.

In this embodiment, the light adjustment liquid crystal film 20 has a single-layer structure. The light adjustment liquid crystal film 20 includes an upper substrate 21, a lower substrate 22 disposed opposite to the upper substrate 21, and a liquid crystal layer 23 disposed between the upper substrate 21 and the lower substrate 22. The upper substrate 21 and the lower substrate 22 are, for example, a glass substrate or a plastic substrate. The upper substrate 21 is provided with an upper electrode 211 on a side thereof facing the lower substrate 22. The lower substrate 22 is provided with a lower electrode 221 on a side thereof facing the upper substrate 21. The upper electrode 211 and the lower electrode 221 are, for example, a whole surface electrode disposed throughout the entire layer and made of a transparent conductive material such as indium tin oxide (ITO) or indium zinc oxide (IZO). When a voltage is applied between the upper electrode 211 and the lower electrode 221, the light adjustment liquid crystal film 20 can change a backlight exit angle θ₁ of the light emitted by the backlight source 30 after passing through the display panel 10.

As shown in FIG. 6, when a voltage is applied between the upper electrode 211 and the lower electrode 221 to cause the liquid crystal molecules in the liquid crystal layer 23 to stand up, the light emitted from the backlight source 30 passes through the light adjustment liquid crystal film 20 in a non-converged manner, and the light entering the display panel 10 is in a scattered manner in all directions. Thus, the light emitted by the backlight source 30 after passing through the display panel 10 has a wider backlight exit angle θ₁, and the display panel 10 is displayed in a wide viewing angle mode.

As shown in FIG. 7, when a voltage is applied between the upper electrode 211 and the lower electrode 221 to cause the liquid crystal molecules in the liquid crystal layer 23 to be in a horizontal state, the light emitted by the backlight source 30 is converged by the light adjustment liquid crystal film 20, and the light entering the display panel 10 becomes a vertical state or a nearly vertical state. Due to the light converging effect of the light adjustment liquid crystal film 20, the luminance of the display panel 10 when viewed from large viewing angle decreases, the backlight exit angle θ₁ of the light emitted from the backlight source 30 and passing through the display panel 10 becomes narrower. Thus, the display panel 10 is finally displayed in a narrow viewing angle mode.

Therefore, an alignment of the liquid crystal molecules in the liquid crystal layer 23 between the upper substrate 21 and the lower substrate 22 can be changed by adjusting the voltage applied between the upper electrode 211 and the lower electrode 221 of the light adjustment liquid crystal film 20, so that the liquid crystal molecules have different refraction effects to the light emitted from the backlight source 30 to accordingly change the backlight exit angle θ₁ of the light emitted by the backlight source 30 and passing through the display panel 10, to finally realize switching between a wide viewing angle mode and a narrow viewing angle mode of the display panel 10.

In addition, when the voltage applied between the upper electrode 211 and the lower electrode 221 continuously changes, the backlight exit angle θ₁ of the light emitted by the backlight source 30 are continuously variable between a maximum exit angle θ₁₋ₘₐₓ and a minimum exit angle θ₁₋ₘᵢₙ after passing through the display panel 10, so that the viewing angle of the display panel 10 is continuously adjustable between a wide viewing angle and a narrow viewing angle. Therefore, the advantage of continuously adjusting the viewing angle of the display panel 10 can be achieved by the light adjustment liquid crystal film 20.

In the use of the display panel 10, the viewing angle in one direction may be needed to be narrower than the viewing angle in another direction, for example, the viewing angle in the left-right direction needs to be narrower than the viewing angle in the up-down direction. In this embodiment, a prism layer is further disposed on the upper substrate 21 of the light adjustment liquid crystal film 20. The prism layer includes a plurality of prisms 212 arranged in parallel to each other. The prisms 212 are arranged side by side along a first direction (e.g., the left-right direction) of the display panel 10, and each of the prisms 212 extends along a second direction (e.g., the up-down direction) of the display panel 10. The prism layer can further converge the light in the left-right direction of the display panel 10, so that the viewing angle of the display panel 10 in the left-right direction is narrower than the viewing angle in the up-down direction.

### Second Embodiment

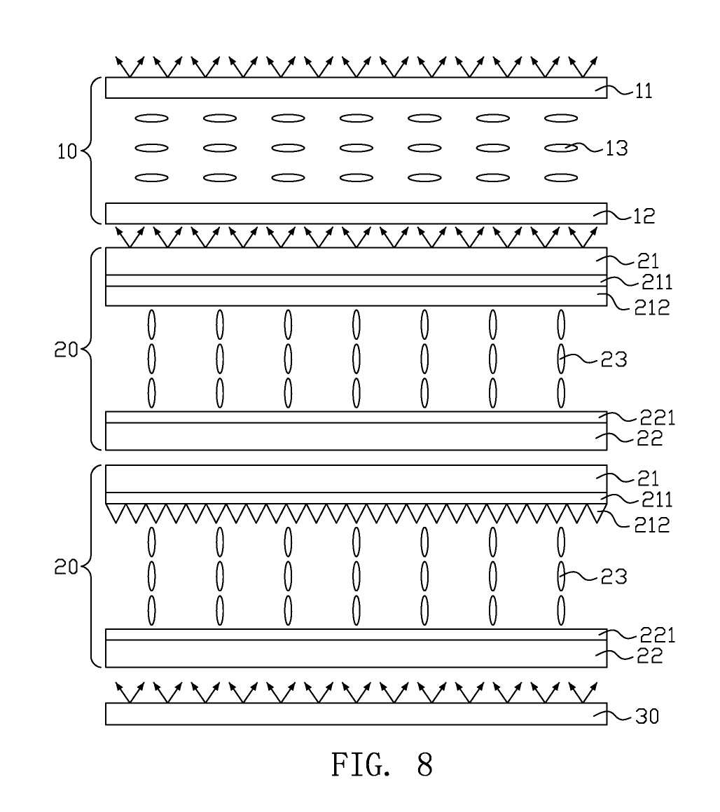

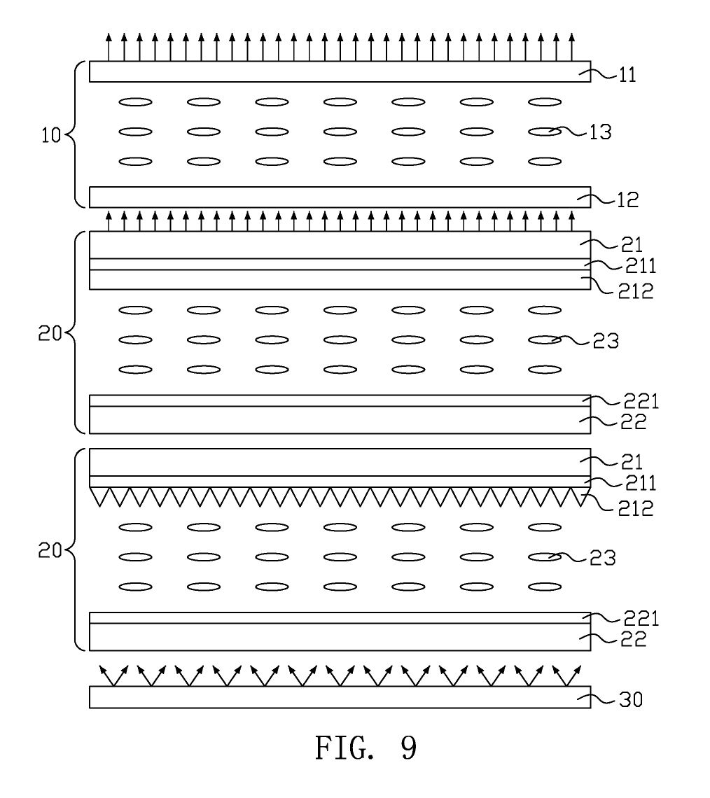

FIG. 8 is a schematic cross-sectional view of a liquid crystal display device in a wide viewing angle mode according to a second embodiment of the present application. FIG. 9 is a schematic cross-sectional view of the liquid crystal display device of FIG. 8 in a narrow viewing angle mode. Referring to FIG. 8 and FIG. 9, the main difference between this embodiment and the above first embodiment lies in that two light adjustment liquid crystal films 20 are disposed between the display panel 10 and the backlight source 30 in this embodiment. The structure for each light adjustment liquid crystal film 20 can refer to the first embodiment described above.

In this embodiment, the arrangement directions of the prism layers on the two light adjustment liquid crystal films 20 are perpendicular to each other. That is, the plurality of prisms 212 in the prism layer of one of the light adjustment liquid crystal films 20 (e.g., the lower light adjustment liquid crystal film) are arranged side by side along a first direction (e.g., the left-right direction) of the display panel 10, and the plurality of prisms 212 in the prism layer of the other light adjustment liquid crystal films 20 (e.g., the upper light adjustment liquid crystal film) are arranged side by side along a second direction (e.g., the up-down direction) of the display panel 10.

Compared with the above first embodiment, two light adjustment liquid crystal films 20 with prisms arranged perpendicular to each other are provided in this embodiment between the display panel 10 and the backlight source 30. By the light converging effect of the two light adjustment liquid crystal films 20, the luminance of the light emitted by the backlight source 30 after passing through the display panel 10 is reduced when viewed from large viewing angle, to realize the narrow viewing angle mode of the display panel 10. In this embodiment, by disposing two light adjustment liquid crystal films 20, the light converging effect of the backlight is more obvious and the effect of the narrow viewing angle is better.

In addition, the voltage may be optionally applied to only one of the light adjustment liquid crystal films 20 according to the actual situation, so as to achieve the light converging effect only in a certain direction, thereby satisfying the requirements of different viewing angles in different situations. For example, when the voltage is only applied to the lower light adjustment liquid crystal film 20, the viewing angle in the left-right direction of the display panel 10 is narrower than the viewing angle in the up-down direction; and when the voltage is only applied to the upper light adjustment liquid crystal film 20, the viewing angle in the up-down direction of the display panel 10 is narrower than the viewing angle in the left-right direction.

Other structures of this embodiment can refer to the above first embodiment, and are omitted herein for clarity.

### Third Embodiment

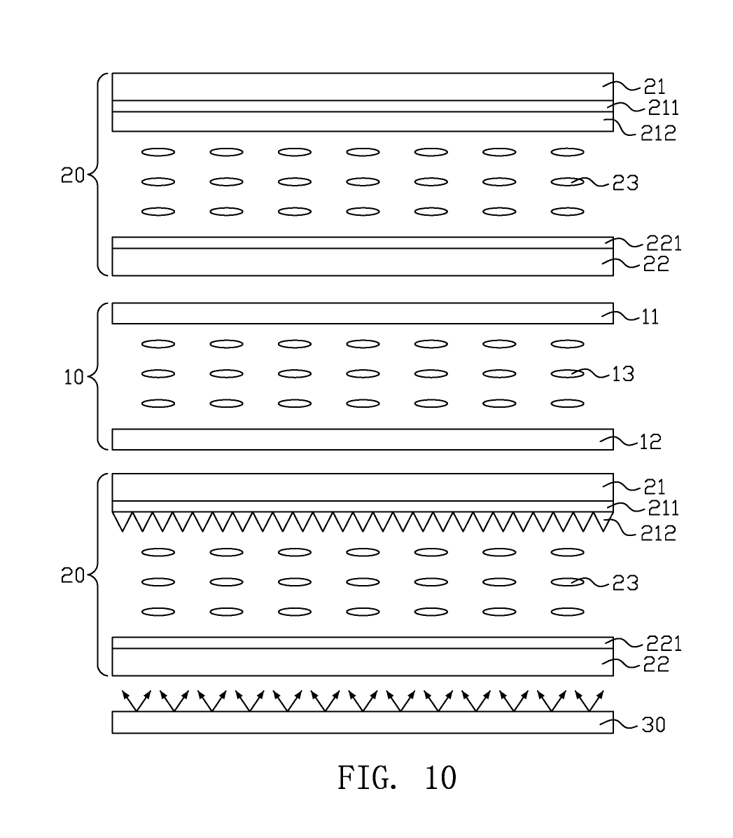

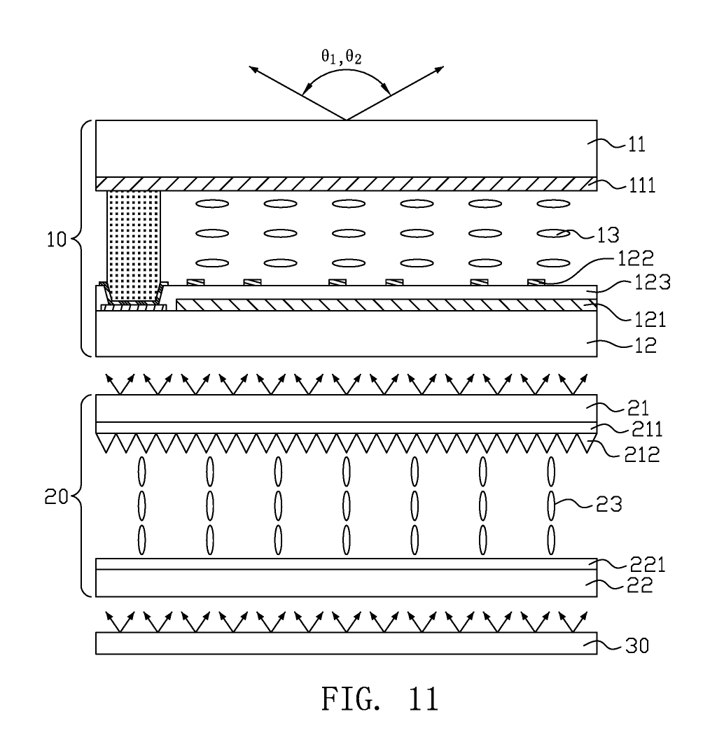

FIG. 10 is a schematic cross-sectional view of a liquid crystal display device according to a third embodiment of the present application. Referring to FIG. 10, the main difference between this embodiment and the above second embodiment lies in that one of the two light adjustment liquid crystal films 20 (i.e., the lower light adjustment liquid crystal film) is disposed between the display panel 10 and the backlight source 30 and the other light adjustment liquid crystal film 20 (i.e., the upper light adjustment liquid crystal film) is disposed above the display panel 10 in this embodiment. That is, the two light adjustment liquid crystal films 20 are respectively disposed on upper and lower sides of the display panel 10.

When a certain voltage is applied to the two light adjustment liquid crystal films 20, the liquid crystal molecules in each light adjustment liquid crystal film 20 stand up, the light emitted by the scattering-type backlight source 30 and passing through the two light adjustment liquid crystal films 20 has no converging effect, so that the light entering the display panel 10 is still in a scattered state, and thus the display panel 10 is displayed in a wide viewing angle mode.

When another voltage is applied to the two light adjustment liquid crystal films 20, the liquid crystal molecules in each of the light adjustment liquid crystal films 20 lie horizontally. The light emitted from the backlight source 30 and passing through the light adjustment liquid crystal film 20 below the display panel 10 is converged and enters the display panel 10 in a collimated direction. Due to the effect of the color filter substrate and the polarizer in the display panel 10, a part of the light will be scattered. However, the light is converged again and becomes a collimated light after passing through the light adjustment liquid crystal film 20 above the display panel 10, so as to reduce the exit angle of the backlight, and thus the display panel 10 is displayed in a narrow viewing angle mode.

Other structures of this embodiment can refer to the above first embodiment and the above second embodiment, and are omitted herein for clarity.

### Fourth Embodiment

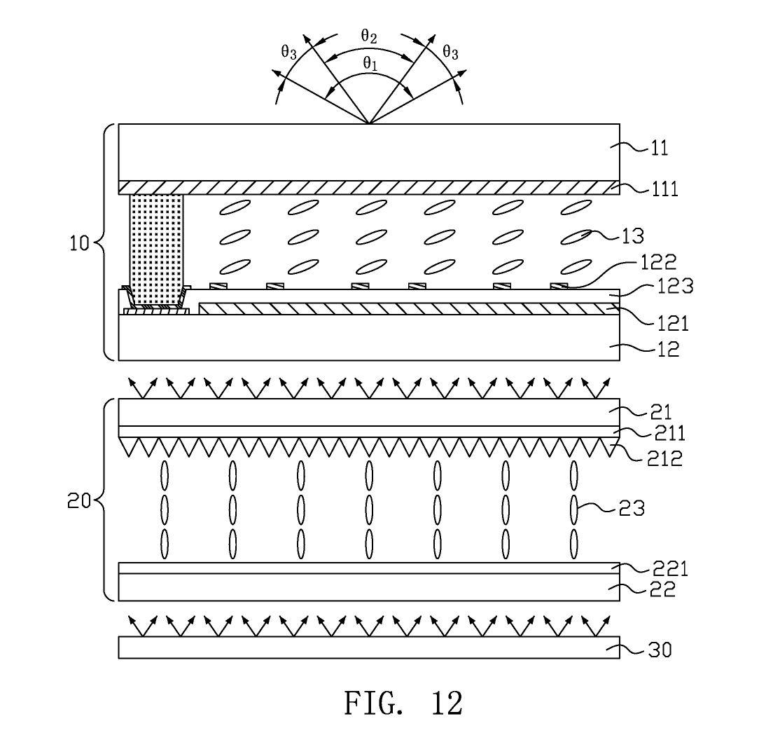

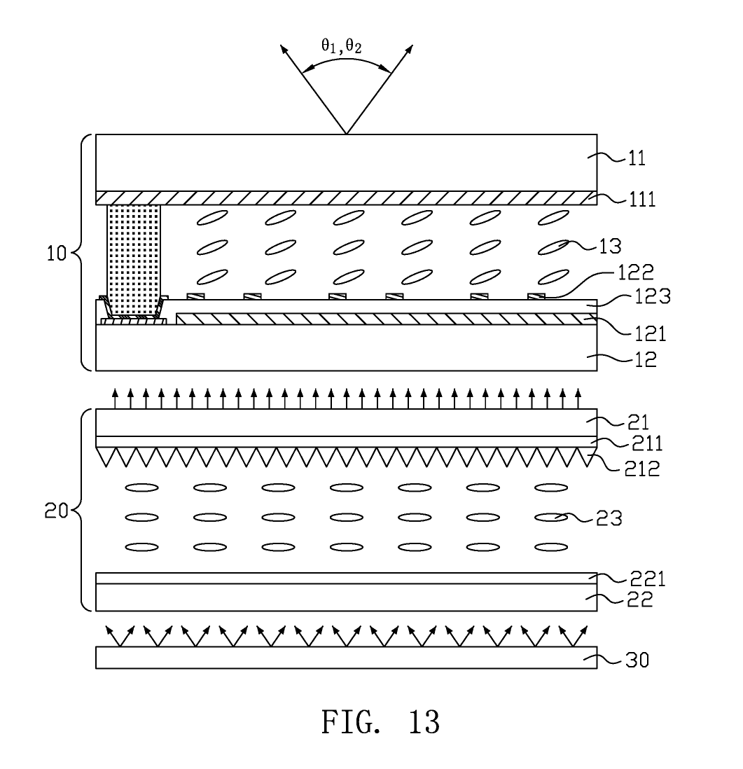

FIG. 11 is a cross-sectional view of a liquid crystal display device in a wide viewing angle mode according to a fourth embodiment of the present application. FIG. 12 is a cross-sectional view of the liquid crystal display device of FIG. 11 for illustrating the white screen phenomenon. FIG. 13 is a schematic cross-sectional view of the liquid crystal display device of FIG. 11 in a narrow viewing angle mode. Referring to FIG. 11 to FIG. 13, the main difference between this embodiment and the above first embodiment lies in that the display panel 10 in this embodiment is an in-plane switching (IPS) display panel using a horizontal electric field or a fringe field switching (FFS) display panel using a fringe electric field. For the IPS or FFS display panel, the common electrode and the pixel electrode are formed on the same substrate (i.e., the thin film transistor array substrate). The liquid crystal molecules are rotated in a plane substantially parallel to the substrate to obtain a wider viewing angle. In this embodiment, the display panel 10 is described by taking the FFS as an example.

In this embodiment, the first substrate 11 is provided with a first electrode 111 on a side facing the second substrate 12. The second substrate 12 is provided with a second electrode 121 and a third electrode 122 on a side facing the first substrate 11. An insulating layer 123 is provided between the second electrode 121 and the third electrode 122. The first electrode 111, the second electrode 121 and the third electrode 122 are made of a transparent material such as indium tin oxide (ITO) or indium zinc oxide (IZO). The first electrode 111 is a viewing angle control electrode of the display panel 10 for being applied with a voltage to control the viewing angle of the display panel 10. The second electrode 121 is a common electrode for being applied with a common voltage (Vcom) for displaying. The third electrode 122 is a pixel electrode formed in each sub-pixel of the display panel 10. In this embodiment, the third electrode 122 is located above the second electrode 121, but the present application is not limited thereto, and the third electrode 122 may be located below the second electrode 121.

The first electrode 111 may be an un-patterned whole surface electrode. The second electrode 121 may be a partially-patterned planar electrode, for example, the second electrode 121 is partially etched away at a position where a thin film transistor (TFT) is formed on the second substrate 12, so that the pixel electrode (i.e., the third electrode 122) can be downwardly and conductively connected to the TFT through the position. The third electrode 122 (i.e., the pixel electrode) located in each sub-pixel may be a bulk electrode or include a plurality of electrode strips.

In addition, when the display panel 10 adopts an in-plane switching (IPS) mode, the second electrode 121 and the third electrode 122 may also be in the same layer and insulated from each other. For example, the second electrode 121 and the third electrode 122 may be respectively formed in a comb-shaped structure having a plurality of electrode strips and inserted with each other.

As shown in FIG. 11, when no voltage is applied between the first electrode 111 and the second electrode 121 of the display panel 10, the liquid crystal molecules in the display panel 10 are horizontally rotated by a strong in-plane electric field formed between the pixel electrode (i.e., the third electrode 122) and the common electrode (i.e., the second electrode 121), and thus the display panel 10 has a wider screen viewing angle θ₂. In addition, a certain voltage is applied between the upper electrode 211 and the lower electrode 221 of the light adjustment liquid crystal film 20 to cause the liquid crystal molecules in the light adjustment liquid crystal film 20 to stand up, the light emitted from the backlight source 30 after passing through the light adjustment liquid crystal film 20 has no converging effect, so that the light entering the display panel 10 is still in a scattered state, the backlight exit angle θ₁ of the backlight source 30 also has a wide viewing angle, and thus the display panel 10 is displayed in a wide viewing angle mode.

As shown in FIG. 12, when a certain voltage is applied between the first electrode 111 and the second electrode 121 of the display panel 10, a vertical electric field is formed between the two substrates 11, 12 of the display panel 10, so that the liquid crystal molecules in the display panel 10 are tilted due to the vertical electric field while rotating horizontally, the contrast of the display panel 10 decreases due to a light leakage, and the screen viewing angle θ₂ of the display panel 10 is narrowed. If the backlight exit angle θ₁ of the backlight source 30 is still in a wide viewing angle, the backlight exit angle θ₁ of the backlight source 30 will be larger than the screen viewing angle θ₂ of the display panel 10, to result in a white screen phenomenon easily occurring in a backlight exit area between the backlight exit angle θ₁ and the screen viewing angle θ₂ (i.e., in an area corresponding to θ₃).

In order to achieve the narrow viewing angle of the display panel 10 and eliminate the white screen problem at the same time, as shown in FIG. 13, when a certain voltage is applied between the first electrode 111 and the second electrode 121 of the display panel 10, the voltage applied between the upper electrode 211 and the lower electrode 221 of the light adjustment liquid crystal film 20 is also adjusted, so that the liquid crystal molecules in the light adjustment liquid crystal film 20 are lying horizontally, the light emitted from the backlight source 30 after passing through the light adjustment liquid crystal film 20 is converged, the luminance of the backlight source 30 in large viewing angle is reduced, the backlight exit angle θ₁ of the backlight source 30 is reduced to be equal to or smaller than the screen viewing angle θ₂ of the display panel 10, so that the display panel 10 is displayed in a narrow viewing angle mode and at the same time the white screen problem is eliminated.

When the voltage applied between the first electrode 111 and the second electrode 121 continuously changes, the screen viewing angle θ₂ of the display panel 10 is continuously variable between a maximum viewing angle θ₂₋ₘₐₓ and a minimum viewing angle θ₂₋ₘᵢₙ, so that the viewing angle of the display panel 10 is continuously adjustable. Therefore, the advantage of continuously adjusting the viewing angle of the display panel 10 is achieved. Moreover, the backlight exit angle θ₁ of the backlight source 30 is also continuously adjustable, and the white screen problem can be completely eliminated by ensuring the backlight exit angle θ₁ being equal to or smaller than the screen viewing angle θ₂.

In this embodiment, the light adjustment liquid crystal film 20 is provided between the display panel 10 and the backlight source 30. By controlling the voltage applied between the upper electrode 211 and the lower electrode 221 of the light adjustment liquid crystal film 20 and using the light converging effect of the light adjustment liquid crystal film 20, the scattered light generated by the backlight source 30 is converged to be perpendicular to the display panel 10, to reduce the luminance of the backlight source 30 in large viewing angle and achieve a narrow viewing angle of the backlight exit angle θ₁. In addition, with the viewing angle adjustment of the display panel 10, by controlling the voltage applied between the first electrode 111 (i.e., the viewing angle control electrode) and the second electrode 121 (i.e., the common electrode) of the display panel 10, the display panel 10 generates a light leakage and the contrast of the screen is reduced, and the screen viewing angle θ₂ becomes narrow. Therefore, in this embodiment, a narrow viewing angle mode can be achieved by simultaneously reducing the contrast of the display panel 10 and reducing the luminance of the backlight source 30 in large viewing angle, to solve the white screen problem as viewed from large viewing angle when displayed in the narrow viewing angle mode in prior art, and thus the viewing angle is narrower and the effect is better.

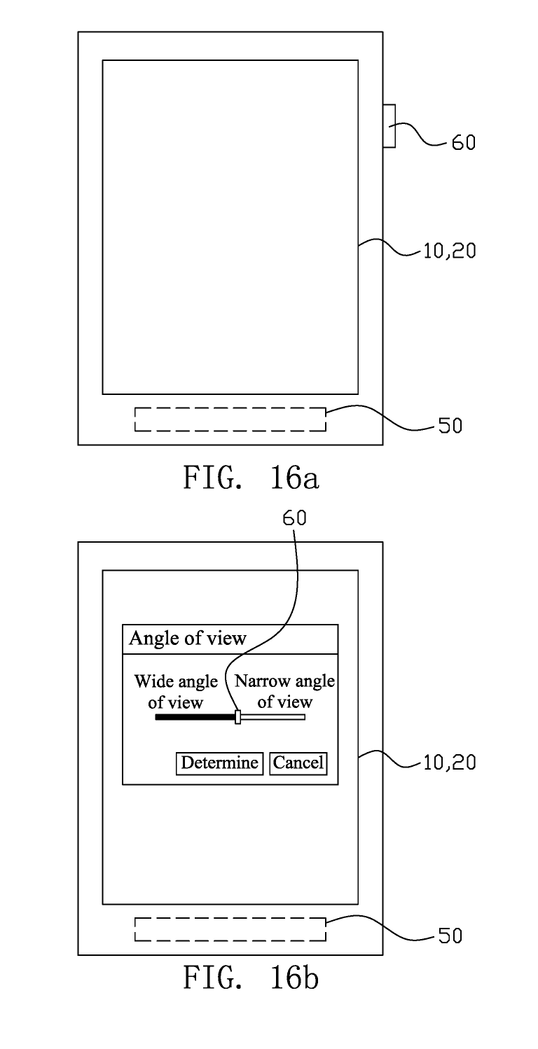

As shown in FIG. 11 and FIG. 13, in order to apply a voltage to the first electrode 111 on the first substrate 11, the first electrode 111 can be electrically conducted from the first substrate 11 to the second substrate 12 through a conductive adhesive (not labelled) in the peripheral non-display area. The driving IC 50 (referring to FIG. 16) first provides a voltage to the second substrate 12, and the second substrate 12 then applies the voltage to the first electrode 111 of the first substrate 11 through the conductive adhesive.

Other structures of this embodiment can refer to the above first embodiment, and omitted herein for clarity.

### Fifth Embodiment

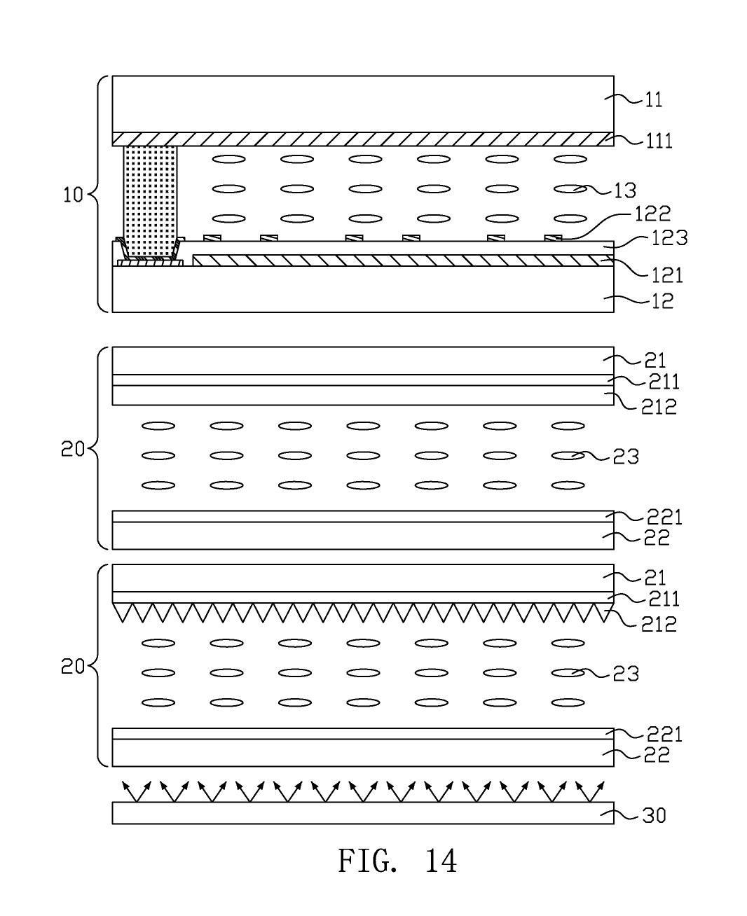

FIG. 14 is a schematic cross-sectional view of a liquid crystal display device according to a fifth embodiment of the present application. Referring to FIG. 14, the main difference between this embodiment and the above fourth embodiment lies in that two light adjustment liquid crystal films 20 are disposed between the display device 10 and the backlight source 30 in this embodiment. The structure for each light adjustment liquid crystal film 20 can refer to the first embodiment described above.

In this embodiment, the arrangement directions of the prism layers on the two light adjustment liquid crystal films 20 are perpendicular to each other. That is, the plurality of prisms 212 in the prism layer of one of the light adjustment liquid crystal films 20 (e.g., the light lower adjustment liquid crystal film) are arranged side by side along a first direction (e.g., the left-right direction) of the display panel 10, and the plurality of prisms 212 in the prism layer of the other light adjustment liquid crystal films 20 (e.g., the upper light adjustment liquid crystal film) are arranged side by side along a second direction (e.g., the up-down direction) of the display panel 10.

Other structures and working principles of this embodiment can refer to the above first embodiment, the above second embodiment and the above fourth embodiment, and are omitted herein for clarity.

### Sixth Embodiment

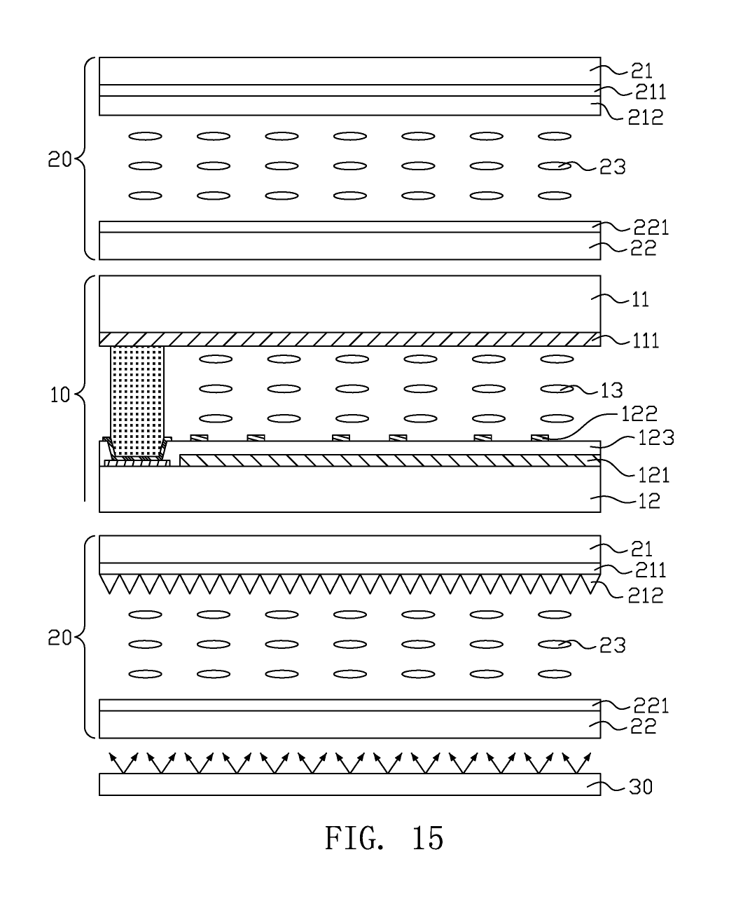

FIG. 15 is a schematic cross-sectional view of a liquid crystal display device according to a sixth embodiment of the present application. Referring to FIG. 15, the main difference between this embodiment and the above fifth embodiment lies in that one of the two light adjustment liquid crystal films 20 (i.e., the lower light adjustment liquid crystal film) is disposed between the display panel 10 and the backlight source 30 and the other light adjustment liquid crystal film 20 (i.e., the upper light adjustment liquid crystal film) is disposed above the display panel 10 in this embodiment. That is, the two light adjustment liquid crystal films 20 are respectively disposed on the upper and lower sides of the display panel 10. Other structures and working principles of this embodiment can refer to the above embodiments, and are omitted herein for clarity.

### Seventh Embodiment

FIGS. 16a to 16b are schematic plan views of a liquid crystal display device according to a seventh embodiment of the present application. Referring to FIGS. 16a to 16b, in this embodiment, the liquid crystal display device includes a display panel 10, a light adjustment liquid crystal film 20, a backlight source 30 and a driving IC 50. The light adjustment liquid crystal film 20 is disposed between the display panel 10 and the backlight source 30, and the light adjustment liquid crystal film 20 may be a single layer or a two-layer structure. The driving IC 50 is configured to drive the display panel 10 and the light adjustment liquid crystal film 20.

In this embodiment, a viewing angle adjusting button 60 is provided on the liquid crystal display device for the user to send a viewing angle adjusting request to the liquid crystal display device. The viewing angle adjusting button 60 may be a physical button (as shown in FIG. 16a), or a virtual button via software control or an application (APP) to realize the switching of viewing angle (as shown in FIG. 16b, the wide and narrow viewing angles can be set by touching the slider). When the viewing angle adjusting button 60 is a physical button (as shown in FIG. 16a), the viewing angle adjusting button 60 can be a thumbwheel or a knob, and the viewing angle of the liquid crystal display device can be continuously adjusted through a rotating operation. Under a normal circumstance, the liquid crystal display device is displayed in a wide viewing angle mode. When there is a demand for privacy protection, the user can send a viewing angle adjusting request by operating the viewing angle adjusting button 60. The driving IC 50 controls to apply a required voltage between the upper electrode 211 and the lower electrode 221 of the light adjustment liquid crystal film 20. By the light converging effect of the light adjustment liquid crystal film 20, the scattered light generated by the backlight source 30 is converged, the luminance of the backlight source 30 in large viewing angle is reduced to realize a narrow backlight exit angle, and thus the display panel 10 is displayed in a narrow viewing angle mode.

Further, when the display panel 10 is the IPS type or the FFS type having wide viewing angle, the driving IC 50 may also control to apply a voltage between the first electrode 111 (i.e., the viewing angle control electrode) and the second electrode 121 (i.e., the common electrode) of the display panel 10 to cause the display panel 10 to generate a light leakage and reduce the contrast of the screen, so as to reduce the screen viewing angle of the display panel 10. Thus, by simultaneously reducing the contrast of the display panel 10 and reducing the luminance of the backlight source 30 in large viewing angle, a narrow viewing angle mode can be achieved, the white screen problem as viewed from large viewing angle in the narrow viewing angle mode can be solved, the viewing angle can be narrower and the effect is better.

When the narrow viewing angle mode is not needed, the user can operate the viewing angle adjusting button 60 again to cancel or change the voltage applied to the display panel 10 and the light adjustment liquid crystal film 20 by the driving IC 50, to return back to the wide viewing angle mode. Therefore, the viewing angle switchable liquid crystal display device in the embodiments of the present application can solve the shortcomings of the existing ways in switching viewing angle, to easily realize the switching between wide and narrow viewing angles on different occasions, having strong operation flexibility and convenience, and integrating entertainment sharing and privacy protection in one multi-functional liquid crystal display device.

### Eighth Embodiment

The eighth embodiment of the present application provides a viewing angle switching method for switching the viewing angle of the above viewing angle switchable liquid crystal display devices. The viewing angle switching method includes:

Applying a voltage between the upper electrode 211 and the lower electrode 221 of the light adjustment liquid crystal film 20 according to a viewing angle adjusting request sent by a user, such that the light adjustment liquid crystal film 20 changes the backlight exit angle θ₁ of the light emitted by the backlight source 30 after passing through the display panel 10, to thereby realize switching between a wide viewing angle mode and a narrow viewing angle mode for the display panel 10.

Further, the viewing angle switching method further includes: applying a voltage between the first electrode 111 and the second electrode 121 of the display panel 10 according to the viewing angle adjusting request sent by the user to change the screen viewing angle θ₂ of the display panel 10. By simultaneously reducing the contrast of the display panel 10 and reducing the luminance of the backlight source 30 in large viewing angle, the narrow viewing angle mode can be achieved, the white screen problem as viewed from large viewing angle when displayed in the narrow viewing angle mode can be solved, the viewing angle can be narrower and the effect is better.

Further, the backlight exit angle θ₁ is controlled to be equal to or smaller than the screen viewing angle θ₂, to completely eliminate the white screen problem.

Further, the liquid crystal display device is provided with a viewing angle adjusting button 60, and the viewing angle adjusting request is sent to the liquid crystal display device via the viewing angle adjusting button 60 by the user. The viewing angle adjusting button 60 may be a physical button or a virtual button.

The viewing angle switching method in this embodiment is in the same concept as the liquid crystal display device in the above embodiments. More details about the viewing angle switching method can refer to the description of the liquid crystal display device described above, and omitted herein for clarity.

The above is only preferred embodiments of the present application and not intended to limit the present application. Any modification, equivalent replacement, improvement within the spirit and principle of the present application should be included in the protection scope of the present application.

### INDUSTRIAL PRACTICABILITY

In the embodiments of the present application, a light adjustment liquid crystal film is disposed between the display panel and the backlight source. When there is a need for privacy protection, a required voltage is applied between the upper electrode and the lower electrode of the light adjustment liquid crystal film, the scattered light generated by the backlight source is converged by the light converging effect of the light adjustment liquid crystal film, the luminance of the backlight source in large viewing angle is reduced to realize a narrow backlight exit angle, so that the display panel is displayed in a narrow viewing angle mode.

Further, when the display panel is the IPS type or the FFS type having wide viewing angle, a voltage is also applied between the first electrode (i.e., the viewing angle control electrode) and the second electrode (i.e., the common electrode) of the display panel, so that the display panel generates a light leakage and reduces the contrast of the screen, to decrease the screen viewing angle of the display panel. Thus, a narrow viewing angle mode can be achieved by simultaneously reducing the contrast of the display panel and reducing the luminance of the backlight source in large viewing angle, thereby solving the white screen problem as viewed from large viewing angle when displayed a narrow viewing angle mode. The viewing angle is narrower and the effect is better.

1. A viewing angle switchable liquid crystal display device, comprising a display panel and a backlight source, wherein the liquid crystal display device further comprises a light adjustment liquid crystal film disposed between the display panel and the backlight source (30), the light adjustment liquid crystal film comprises an upper substrate, a lower substrate disposed opposite to the upper substrate, and a liquid crystal layer located between the upper substrate and the lower substrate, the upper substrate is provided with an upper electrode on a side thereof facing the lower substrate, the lower substrate is provided with a lower electrode on a side thereof facing the upper substrate, the light adjustment liquid crystal film is configured to change a light exit angle of the light emitted by the backlight source after passing through the display panel by applying a voltage between the upper electrode and the lower electrode.

2. The viewing angle switchable liquid crystal display device according to claim 1, wherein when the voltage applied between the upper electrode and the lower electrode continuously changes, the backlight exit angle is continuously variable between a maximum exit angle and a minimum exit angle.

3. The viewing angle switchable liquid crystal display device according to claim 1, wherein the upper substrate is further provided with a prism layer, the prism layer comprises a plurality of prisms, the prisms are arranged side by side along a first direction of the display panel, and each prism extends along a second direction of the display panel.

4. The viewing angle switchable liquid crystal display device according to claim 3, wherein the light adjustment liquid crystal film has two in quantity, and arrangement directions of the prism layers on the two light adjustment liquid crystal films are perpendicular to each other.

5. The viewing angle switchable liquid crystal display device according to claim 4, wherein one of the two light adjustment liquid crystal films is disposed between the display panel and the backlight source, and the other light adjustment liquid crystal film is disposed above the display panel.

6. The viewing angle switchable liquid crystal display device according to claim 1, wherein the liquid crystal display device is provided with a viewing angle adjusting button for sending a viewing angle adjusting request to the liquid crystal display device.

7. The viewing angle switchable liquid crystal display device according claim 1, wherein the display panel comprises a first substrate, a second substrate disposed opposite to the first substrate, and a liquid crystal layer located between the first substrate and the second substrate, the first substrate is provided with a first electrode on a side thereof facing the second substrate, the second substrate is provided with a second electrode and a third electrode on a side thereof facing the first substrate, the second electrode is a common electrode, the third electrode is a pixel electrode, and a screen viewing angle of the display panel is changed by applying a voltage between the first electrode and the second electrode.

8. The viewing angle switchable liquid crystal display device according to claim 7, wherein when the voltage applied between the first electrode and the second electrode continuously changes, the screen viewing angle is continuously variable between a maximum viewing angle and a minimum viewing angle.

9. A viewing angle switching method of a liquid crystal display device, the liquid crystal display device comprising a display panel and a backlight source, wherein the liquid crystal display device further comprises a light adjustment liquid crystal film disposed between the display panel and the backlight source, the light adjustment liquid crystal film comprises an upper substrate, a lower substrate disposed opposite to the upper substrate, and a liquid crystal layer located between the upper substrate and the lower substrate, the upper substrate is provided with an upper electrode on a side thereof facing the lower substrate, the lower substrate is provided with a lower electrode on a side thereof facing the upper substrate, wherein the viewing angle switching method comprises:
applying a voltage between the upper electrode and the lower electrode according to a viewing angle adjusting request, such that a backlight exit angle of the light emitted from the backlight source after passing through the display panel is changed by the light adjustment liquid crystal film.

10. The viewing angle switching method of the liquid crystal display device according to claim 9, wherein the display panel comprises a first substrate, a second substrate disposed opposite to the first substrate, and a liquid crystal layer located between the first substrate and the second substrate, the first substrate is provided with a first electrode on a side thereof facing the second substrate, the second substrate is provided with a second electrode and a third electrode on a side thereof facing the first substrate, the second electrode is a common electrode, the third electrode is a pixel electrode, wherein the viewing angle switching method further comprises:
applying a voltage between the first electrode and the second electrode according to a viewing angle adjusting request, such that a screen viewing angle of the display panel is changed.

11. The viewing angle switching method of the liquid crystal display device according to claim 10, wherein the backlight exit angle is controlled to be equal to or smaller than the screen viewing angle.

12. The viewing angle switching method of the liquid crystal display device according to claim 9, wherein the liquid crystal display device is provided with a viewing angle adjusting button, and the viewing angle adjusting request is sent to the liquid crystal display device via the viewing angle adjusting button.
